(19) United States
(12) Patent Application Publication
(10) Pub. No.: US 2011/0051093 A1
(43) Pub. Date: Mar. 3, 2011

(54) POLARIZATION CONVERSION APPARATUS AND PROJECTION SYSTEM USING SAME

(75) Inventor: Lujie Qu, Shenzhen (CN)

(73) Assignee: Butterfly Technology (Shenzhen) Limited, Shenzhen (CN)

(21) Appl. No.: 12/547,890

(22) Filed: Aug. 26, 2009

(51) Int. Cl. G02B 27/28; G03B 21/14

(52) U.S. Cl. 353/20; 359/487

(57) ABSTRACT

A polarization conversion apparatus capable of converting natural incident light into linear light with single polarization for emission includes a plurality of prisms arrayed as a whole component, a plurality of half-wave plates arranged at emission surfaces of some of the prisms, and a plurality of faying surfaces defined inside and a plurality of side surfaces defined outside. Some of the faying surfaces include polarization beam splitting films formed thereon to form polarization beam splitting surfaces, and one faying surface and the side surfaces include total reflection films formed thereon to form total reflection surfaces.

### FIELD OF THE DISCLOSURE

The present disclosure relates to a polarization conversion apparatus capable of converting natural light from a light source into linearly polarized light with same polarization, and a single-chipped liquid crystal on silicon (LCOS) projection system using the polarization conversion apparatus.

### GENERAL BACKGROUND

A typical single-chipped reflective liquid crystal projection system is described in FIG. 1. The projection system includes a light source 1, a polarization beam splitter 2, a reflective liquid crystal panel 3, and a projection lens 4. The light source 1 can be selected from many kinds of light sources, and can include one or more filters for filtering ultraviolet and infrared light, focusing lens assemblies, or a light rod. Light from the light source 1 is split into light with p-polarization and light with s-polarization. The light with s-polarization is used to illuminate the liquid crystal panel 3, while the light with p-polarization emits out and is wasted. Therefore, a light utilization ratio of the projection system is low, and brightness of the projection system is correspondingly weak.

In order to overcome the above-described defects, a polarization conversion system (PCS) is used. The polarization conversion system converts natural light into one kind of polarized light for improving a light utilization ratio. A typical polarization conversion system shown in FIG. 2 includes two prisms glued together, and a faying surface of the prisms is coated with a polarization beam splitting film. A half-wave plate is arranged at a surface of the prism from which light with p-polarization emits for converting the light with p-polarization into light with s-polarization, and a side surface of the other prism is coated with a reflective film for reflecting the light with s-polarization. Therefore, light emitting from the polarization conversion system is light with single s-polarization. Another typical polarization conversion system shown in FIG. 3 includes three prisms glued together, and a half-wave plate is arranged at an emission surface of a middle one of the prisms. It can be seen from FIG. 3 that emission light from the polarization conversion system is pure light with s-polarization.

The structures of the above-described polarization conversion systems are both very simple, and are disclosed in China patent CN02217355.2 and U.S. Pat. No. 7,281,803, respectively. However, light with s-polarization emitting from the two polarization conversion systems is non-uniform. If a plurality of micro polarization conversion systems are arrayed together, emission light from the polarization conversion system will be uniform. As is disclosed in China patent CN200480011836.6 and several foreign patents, a polarization conversion system array 01 shown in FIG. 4 includes a plurality of linearly prisms glued together. A plurality of half-wave plates 7 are alternately arranged at an emission surface of the polarization conversion system array 01. An incident surface of the polarization conversion system array 01 is divided into a plurality of alternately staggered transparent portions and non-transparent portions. The non-transparent portions can prevent light from entering into the polarization conversion system array 01 therefrom in order to avoid existence of natural light or light with p-polarization emitting from the polarization conversion system array 01. Micro-lens arrays 02, 03 are needed to ensure light from a light source enter into the polarization conversion system array 01 only from the transparent portions. That is, the polarization conversion system array 01 has a complex structure and a high cost.

A further polarization conversion system array 04 shown in FIG. 5 is disclosed in US patent publication US20070008494. The polarization conversion system array 04 includes a plurality of linearly arrayed prisms. An emission surface of the polarization conversion system array 04 is divided into a plurality of transparent portions and non-transparent portions, and a plurality of half-wave plates are arranged corresponding to the transparent portions, respectively. An arrangement and structures of some prisms of the polarization conversion system array 04 are different from those of the prisms of polarization conversion system array 01, which can be seen from FIG. 4 and FIG. 5. For using the polarization conversion system array 04 to completely convert natural light into light with s-polarization, the micro-lens arrays 05, 06 are needed for guiding light from a light source. Therefore, guided light only illuminates the transparent portions, and the light from the light source is fully used and the incident light is completely converted into light with s-polarization within the polarization conversion system array 04. However, the polarization conversion system array 04 also obviously has a complex design and a corresponding high cost.

What is needed, therefore, is a polarization conversion apparatus that can overcome the described limitations, as well as a projection system employing the polarization conversion apparatus.

### SUMMARY

The present disclosure has been made in the light of the above problems, and an object of the present disclosure is therefore to provide a polarization conversion apparatus. The polarization conversion apparatus is capable of completely converting natural incident light into uniform light with single polarization. The present disclosure also provides a projection system employing the polarization conversion apparatus without the need of micro-lens array. Therefore, the difficulty of designing an appropriate light source can be decreased, and a cost is correspondingly lowered. The projection system can provide an improved optical performance.

A polarization conversion apparatus capable of converting natural incident light into linear light with single polarization has the characteristic described below:
(1) The polarization conversion apparatus includes a first prism, a second prism, a third prism, a fourth prism, a fifth prism, a six prism and a seventh prism arranged in that order as a whole component. The fourth prism is right-angled isosceles triangle prism or glued right-angled isosceles triangle prism composed of two right-angled triangle sub-prisms. The first prism, the second prism, the third prism, the fifth prism, the sixth prism and the seventh prism are single constant parallelogram prisms or glued parallelogram prisms composed of two right-angled triangle sub-prisms. The first prism, the second prism, the third prism are arranged at one right-angled side of the fourth prism, and the fifth prism, the sixth prism and the seventh prism are arranged at the other right-angled side of the fourth prism and are symmetric relative to the first prism, the second prism, the third prism.
(2) A plurality of half-wave plates is provided at all emission surfaces of the prisms from which light with p-polarization or s-polarization emit.
(3) Said polarization conversion apparatus includes a first faying surface between the first prism and the second prism, a second faying surface between the second prism and the third prism, a third faying surface between the third prism and the fourth prism, a fourth faying surface between the fourth prism and the fifth prism, a fifth faying surface between the fifth prism and the sixth prism, a sixth faying surface between the sixth prism and the seventh prism, a first outer side surface of the first prism, and a second outer side surface of the seventh prism. The first faying surface, the third faying surface, the fourth faying surface and the sixth faying surface each include polarization beam splitting films arranged thereon to form polarization beam splitting surfaces, the first outer side surface, the second faying surface, the fifth faying surface and the second outer side surface each include total reflection films thereon to form total reflection surfaces.

A projection system includes a light source, a polarization beam splitter, a display chip, and at least one projection lens, thereby forming projection light paths, and said polarization conversion apparatus. The polarization conversion apparatus is located between the light source and the polarization beam splitter to convert natural light from the light source into linear light with single polarization for the polarization beam splitter.

Another projection system has the following characteristic. The projection system includes a red light source, a green light source, a blue light source, a beam combining cubic prism, a polarization beam splitter, an LCOS panel, and a projection lens. The red light source, the green light source, and the blue light source are located corresponding to three side surfaces of the beam combining cubic prism, respectively. Light from the light sources is combined into the polarization beam splitter, and is further split into light with linear polarization for providing to the LCOS panel. The light with linear polarization is modulated by the LCOS panel, and is projected out the projection lens. At least one polarization conversion apparatus is provided between each light source and the beam combining cubic prism.

The present disclosure further provides another polarization converter which is a symmetric half of the above polarization conversion apparatus.

Compared with prior arts, the present disclosure has following advantages.

Only seven linearly arrayed micro prisms are needed to form the polarization conversion system, which results in a simple structure of the polarization conversion system and an improved optical performance. The polarization conversion apparatus has an emission surface much greater than an incident surface thereof, and light emitting from the polarization conversion apparatus is uniform.

Besides the first prism and the seventh prism, the incident surfaces of the other five prisms cooperatively serve as effective light receiving portions. The light from the light source can be fully used and converted into light with single polarization if the parallel light from the light source illuminates the effective light receiving portions.

There is no need of employing any micro-lens array in the light conversion apparatus for the light from the light source. The light from the light source can directly enter into the polarization conversion apparatus, and is converted to light with single polarization and passes through the polarization beam splitter until it reaches the display chip. Thus, the projection system has a simplified optical design and a decreased cost.

Other advantages and novel features will become more apparent from the following detailed description of preferred embodiments when taken in conjunction with the accompanying drawings, in which:

### BRIEF DESCRIPTION OF THE DRAWINGS

The components in the drawings are not necessarily drawn to scale, the emphasis instead being placed upon clearly illustrating the principles of at least one embodiment of the present disclosure. In the drawings, like reference numerals designate corresponding parts throughout various views, and all the views are schematic.

FIG. 1 shows a side, cross view of a conventional single-chipped reflective liquid crystal projection system.

FIG. 2 and FIG. 3 show another two conventional polarization conversion systems, respectively.

FIG. 4 shows a further conventional polarization conversion system.

FIG. 5 shows a still further conventional polarization conversion system.

FIG. 6 shows a polarization conversion apparatus of the present disclosure.

FIG. 7 shows a projection system employing the polarization conversion apparatus of FIG. 6.

FIG. 8 shows another projection system of the present disclosure.

FIG. 9 shows an alternative polarization conversion apparatus with differently arranged half-wave plates.

FIG. 10 shows a further projection system employing the polarization conversion apparatus of FIG. 9.

FIG. 11 shows alternative structures of the polarization conversion apparatuses of the present disclosure.

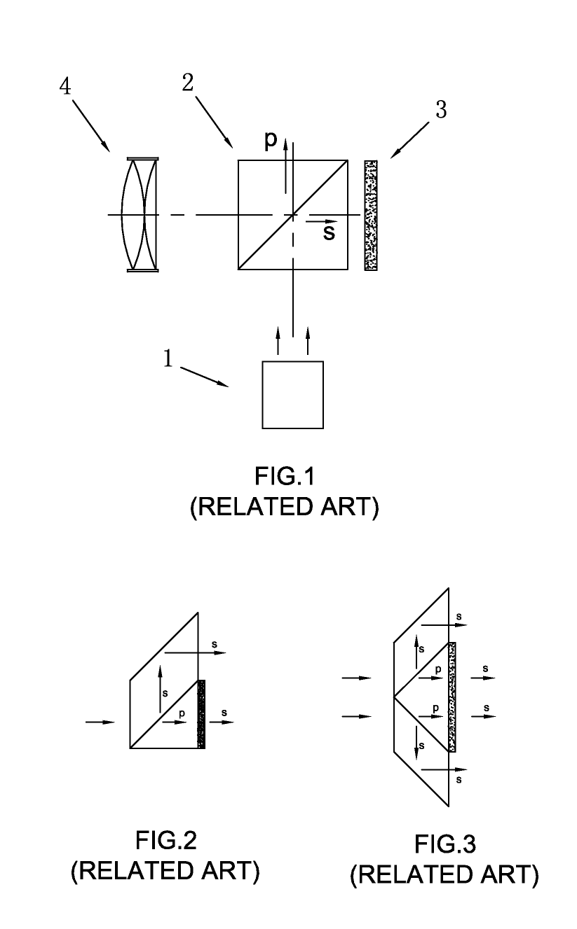

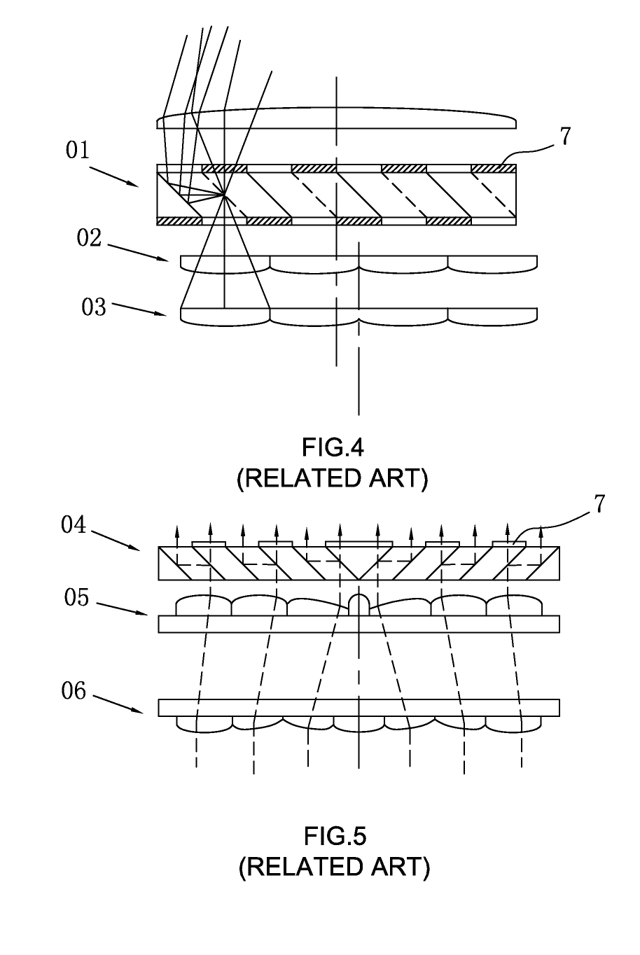

### DETAILED DESCRIPTION OF PREFERRED EMBODIMENTS

Reference will now be made to the drawings to describe preferred and exemplary embodiments in detail.

A first polarization conversion apparatus of the present disclosure is capable of converting natural light into light with s-polarization, and a second polarization conversion apparatus of the present disclosures is capable of converting natural light into light with p-polarization. The first and second polarization conversion apparatuses share the same spirit only with the difference of changing a half-wave plate. For example, the polarization conversion system in FIG. 2 can completely convert the natural light into light with p-polarization if the half-wave plate is moved to the emission surface of the former prism, which simple change has been disclosed by existed patents.

The first polarization conversion apparatus of the present disclosure is described below.

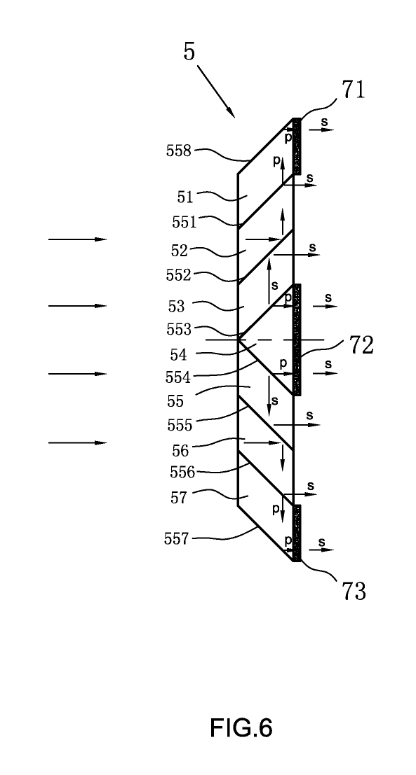

Referring to FIG. 6, the polarization conversion apparatus includes seven prisms 51, 52, 53, 54, 55, 56 and 57 arrayed in that order as a single component. A cross section of the fourth prism 54 is a right-angled isosceles triangle, and cross sections of the other six prisms are constant parallelograms. The prisms 51, 52 and 53 are arranged at one side of the fourth prism 54, and the prisms 55, 56 and 57 are arranged at the other side of the fourth prism 54 and are symmetric with the prisms 51, 52 and 53 relative to a center of the fourth prism 54.

Alternatively, the prisms 51, 52, 53, 54, 55, 56 and 57 can be glued prisms. That is, each of the prisms 51, 52, 53, 55, 56, 57 may be a parallelogram prism composed of two right-angled triangle sub-prisms, and the fourth prism 54 is a right-angled isosceles triangle prism composed of two right-angled triangle sub-prisms.

The first prism 51, the fourth prism 54, and the seventh prism each have half-wave plates 71, 72, 73 arranged at emission surfaces thereof, respectively. The half-wave plates 71, 72, 73 are capable of converting light with one kind of polarization into light with another kind of polarization, for example, from linear light with p-polarization into linear light with s-polarization.

The seven orderly arrayed prism cooperatively define six inner faying surfaces 551, 552, 553, 554, 555, 556, and two outer side surfaces 558, 557. The first faying surface 551 is defined between the first prism 51 and the second prism 52. The second faying surface 552 is defined between the second prism 52 and the third prism 53. The third faying surface 553 is defined between the third prism 53 and the fourth prism 54. The fourth faying surface 554 is defined between the fourth prism 54 and the fifth prism 55. The fifth faying surface 555 is defined between the fifth prism 55 and the sixth prism 56. The sixth faying surface 556 is defined between the sixth prism 56 and the seventh prism 57. The first outer side surface 558 is a side surface of the first prism 51, and the second outer side surface 557 is a side surface of the seventh prism 57. The first faying surface 551, the third faying surface 553, the fourth faying surface 554, and the sixth faying surface 556 include polarization beam splitting films thereon serving as polarization beam splitting surfaces. The first outer side surface 558, the second faying surface 552, the fifth faying surface 555, and the second side surface 557 include total reflective films thereon serving as total reflection surfaces. The total reflective films are preferably metal reflective films having good reflective performance.

The seven prisms 51, 52, 53, 54, 55, 56 and 57 are glued together as a whole component, and the half-wave plates 71, 72, and 73 are respectively glued to the first prism 51, the fourth prism 54, and the seventh prism 57. Thus, the polarization conversion apparatus 5 has a compact structure.

The polarization conversion apparatus 5 is capable of fully converting natural incident light into light with s-polarization for emission, as illustrated in FIG. 6.

The incident light enters into the second prism 52, and is reflected toward the polarization beam splitting surface 551 by the total reflection surface 552, and is separated into light with s-polarization and light with p-polarization. The light with s-polarization emits from the second prism 52. The light with p-polarization enters into the first prism 51, and is guided to the total reflection surface 558. Then, the light with s-polarization is reflected into the half-wave plate 71, and is finally converted into light with s-polarization for emission.

The light entering into the third prism 53 is split into light with p-polarization and light with s-polarization by the polarization beam splitting surface 553. The light with p-polarization directly transmits through the fourth prism 54 and enters into the half-wave plate 72, and is further converted into light with s-polarization for emission. The light with s-polarization emitting from the polarization beam splitting surface 553 reaches the total reflection surface 552, and is reflected to emit from the third prism 53.

The light entering the fourth prism 54 is pure light with p-polarization, and is converted into light with s-polarization for emission by the half-wave plate 72.

The light entering into the fifth prism 55 is split into light with p-polarization and light with s-polarization by the polarization beam splitting surface 554. The light with p-polarization directly transmits through the fourth prism 54 and enters into the half-wave plate 72, and is further converted into light with s-polarization for emission. The light with s-polarization emitting from the polarization beam splitting surface 554 reaches the total reflection surface 555, and is reflected to emit from the prism 55.

The light entering into the sixth prism 56 is reflected toward the polarization faying surface 556 by the total reflection surface 555, and is split into light with p-polarization and light with s-polarization by the polarization beam splitting surface 556. The light with s-polarization emits from the prism 56. The light with p-polarization enters into the seventh prism 57, and is guided to the total reflection surface 557. Then, the light with p-polarization is reflected into the half-wave plate 73, and is further converted into light with s-polarization for emission.

To ensure the natural incident light is completely converted into light with s-polarization for emission by the polarization conversion apparatus 5, the first prism 51 and the seventh prism 57 are unable to receiving incident light, otherwise light with p-polarization will be generated and emit from the polarization conversion apparatus 5. Therefore, incident surfaces of all the prisms besides prism 51 and 57 cooperative serve as effective light incident areas of the polarization conversion apparatus 5, which are the total areas of the incident surfaces of the prism 52, 53, 55 and 56. The polarization conversion apparatus 5 can fully use the light from the light source if the incident light illuminates the effective light incident areas. Further, light shielding layers can be arranged at the light incident surfaces of the first prism 51 and the seventh prism 57 in order to avoid unnecessary light entering into the first prism 51 and the seventh prism 57.

The light emission areas of the polarization conversion apparatus 5 are obviously greater than those of the light incident areas. Therefore, the light with s-polarization emitting from the polarization conversion apparatus 5 is uniform.

The polarization conversion apparatus 5 employs seven prisms 51, 52, 53, 54, 55, 56 and 57, which means the polarization conversion apparatus 5 can achieve a thin structure, and will occupy less space when the polarization conversion apparatus 5 is used in a projection system.

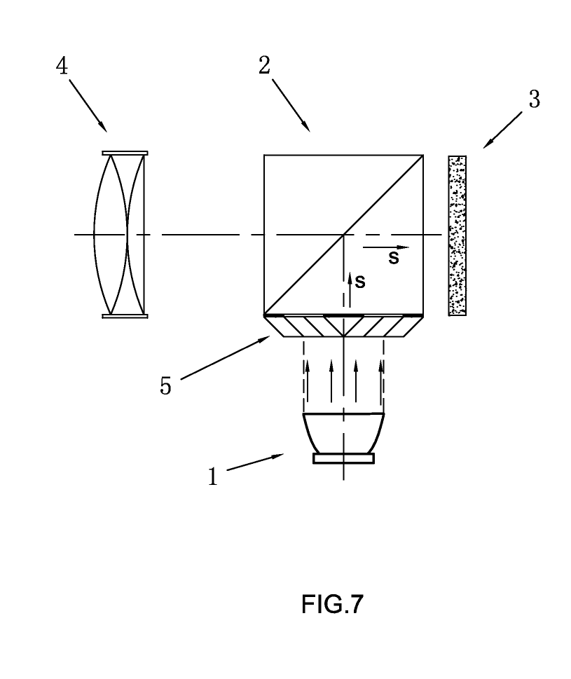

Referring to FIG. 7, a projection system of the present disclosure includes the polarization apparatus 5, and further includes a light source 1, a polarization beam splitter 2, a display chip 3, and a projection lens 4 cooperatively defining a projection light path. The light source 1 can be selected from, for example, mercury lamp, metal halide lamp, light emitting diode (LED) or laser. The light source is preferably LED or laser or arrayed LED and LD. The light source 1 includes a shaping and focusing lens that can provide collimating parallel light. The polarization conversion apparatus 5 is located between the light source 1 and the polarization beam splitter 2, and converts natural light from the light source into light with s-polarization for the polarization beam splitter 2. The light with s-polarization is then reflected to the display chip 3 by the polarization beam splitter 2, and is further modulated by the display chip 3 for emission. The modulated light transmits through the polarization beam splitter 2, and finally emits from the projection lens 4. The display chip 3 is a single-chipped reflective liquid crystal panel, and is preferably an LCOS panel.

The light source 1 can be adjusted so that light therefrom illuminates the incident surfaces of the prisms (see dashed portions in FIG. 7) except those of the first prism 51 and the seventh prism 57 of the polarization conversion apparatus 5. Therefore, the light from the light source 1 can be fully used, and fully converted into light with s-polarization by the polarization conversion apparatus 5 to illuminate the display chip 3. Thus, the projection system has an improved light utilization ratio, and correspondingly improved brightness of displayed images. Further, light shielding layers can be arranged on the light incident surfaces of the first prism 51 and the seventh prism 57 for avoiding unnecessary light.

Preferably, the polarization conversion apparatus 5 and the polarization beam splitter 2 can be glued together for achieving a compact structure and improved reliability.

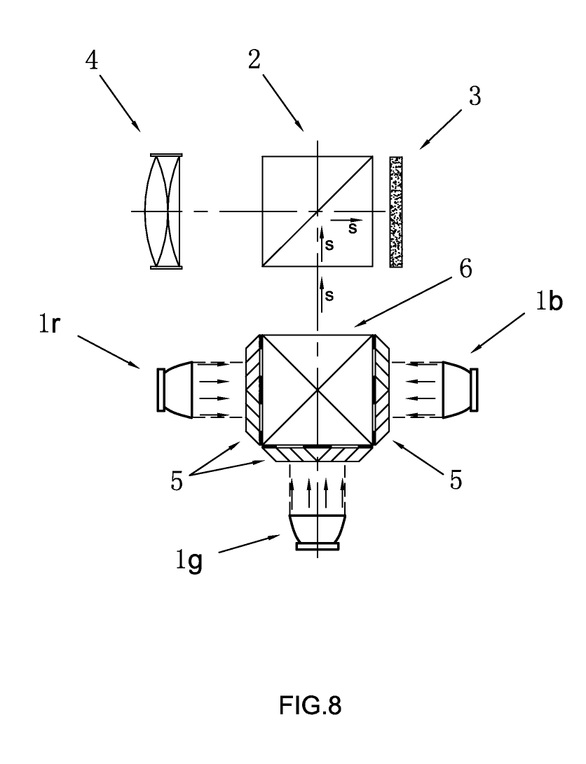

Further or alternative embodiments may include the following. Referring to FIG. 8, another projection system of the present disclosure includes a red light source 1r, a green light source 1g, a blue light source 1b, a beam combining cubic prism (X-cube prism) 6, a polarization beam splitter 2, an LCOS panel 3, and a projection lens 4. The red, green and blue light sources 1r, 1g and 1b correspond to three side surfaces of the beam combining cubic prism 6, respectively, and the light emitting therefrom is combined into the polarization beam splitter 2. Light with s-polarization is split by the polarization beam splitter 2, and is provided to the LCOS panel 3 for light modulation. The modulated light finally emits from the projection lens 4 to display images. Between every light source and the beam combining cubic prism 6, there is one above-described polarization conversion apparatus 5. Preferably, the three polarization conversion apparatuses 5 and the beam combining cubic prism 6 are glued as a whole component for achieving a compact structure.

The single-chipped projection system having the three light sources employs the three polarization conversion apparatuses, can achieve the following advantages. The light from the three light sources 1r, 1g and 1b is converted into light with s-polarization by the polarization apparatuses 5 before entering into the beam combining cubic prism 6, and is further combined to emit toward the polarization beam splitter 2. Then, the combined light is totally reflected toward the LCOS panel 3 by the polarization beam splitter 2. That is, the LCOS panel 3 makes full use of the light from the light sources 1r, 1g and 1b, and light with p-polarization is not generated, which avoids the related light loss. Therefore, the projection system has an improved light utilization ratio, uniformity, and improved quality of images displayed. As is shown in FIG. 7, light emitting from the red light source 1r, the green light source 1g, and the blue light source 1b is illustrated in closed dashing area.

Although the present disclosure currently disclosures two kinds projection systems employing the polarization conversion apparatus 5, it will be apparent that the polarization conversion apparatus 5 can be employed in all kinds of projection systems.

Furthermore, the polarization conversion apparatus 5 of the present disclosure is capable of completely converting natural light into light with s-polarization in order to make full use of light to illuminate the display chip 3 for avoiding loss of light. However, the polarization conversion apparatus 5 can also completely convert natural light into light with p-polarization by making simple changes. For example, by changing the position of the display chip 3, the light with p-polarization can be fully used to illuminate the display chip 3, which also achieves the same aspect of making full use of light and avoiding loss of light.

Another polarization conversion apparatus 5′ of the present disclosure is described below.

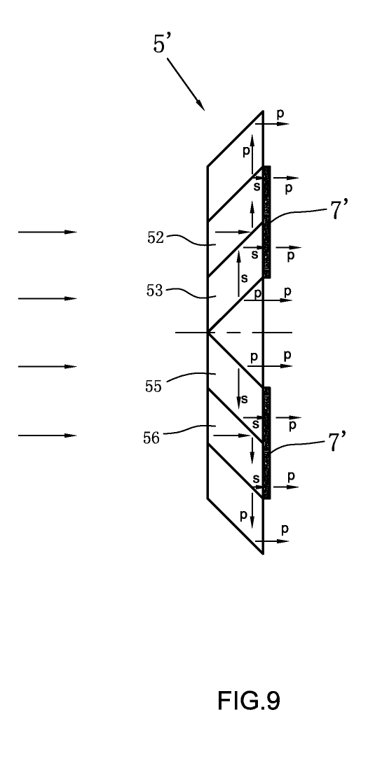

Referring to FIG. 9, the polarization conversion apparatus 5′ can be obtained by changing positions of the half-wave plates of the above-described polarization conversion apparatus 5. That is, the polarization conversion apparatus 5′ is similar to the polarization conversion apparatus 5 only except that the half-wave plates 7′ are arranged on the emission surfaces of the second prism 52, the third prism 53, the fifth prism 55 and the sixth prism 56.

The polarization conversion apparatus 5′ is capable of completely converting the natural light into light with p-polarization for emission, as is shown in FIG. 9. One of ordinary skill in the art can easily understand the principle of the polarization conversion apparatus 5′ after reading the present disclosure. The polarization conversion apparatus 5′ has advantages similar to those of the above polarization conversion apparatus 5, and can provide uniform light with p-polarization.

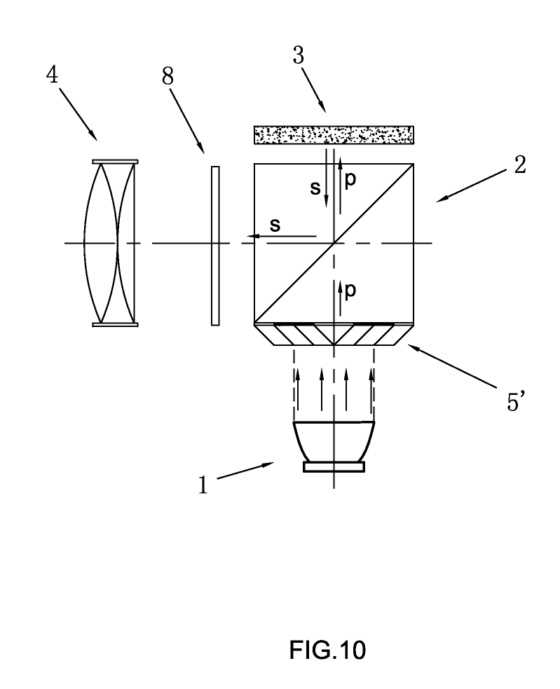

Referring to FIG. 10, another projection system of the present disclosure employing the above polarization conversion apparatus 5′ is shown. The projection system includes a light source 1, a polarization beam splitter 2, a liquid crystal display chip 3, and a projection lens 4. The polarization conversion apparatus 5′ is located between the light source 1 and the polarization beam splitter 2 for converting the natural light from the light source 1 into light with p-polarization. The light with p-polarization from the polarization beam splitter 2 illuminates the liquid crystal display chip 3, and is modulated to light with s-polarization by the liquid crystal display chip 3. The modulate light with s-polarization is then reflected to the projection lens 4 by the polarization beam splitter 2.

Preferably, a polarizer 8 is further provided between the polarization beam splitter 2 and the projection lens 4 for filtering a spot of light with p-polarization. Therefore, the purity of the light with s-polarization is further improved, and a display contrast is correspondingly improved. Furthermore, the polarization conversion apparatus 5′ and the polarization beam splitter 2 are glued together, which results in a compact structure and improved reliability.

The projection system employing the polarization conversion apparatus 5′ has principle of the light source 1 same as that of the polarization conversion apparatus 5. That is, parallel light from the light source 1 all illuminates the incident surfaces of the prisms 52, 53, 55 and 56 (see dashed portions in FIG. 10). Therefore, the polarization conversion apparatus 5′ is capable of fully converting the natural light into light with p-polarization, and the projection system can make full use of the light from the light source 1.

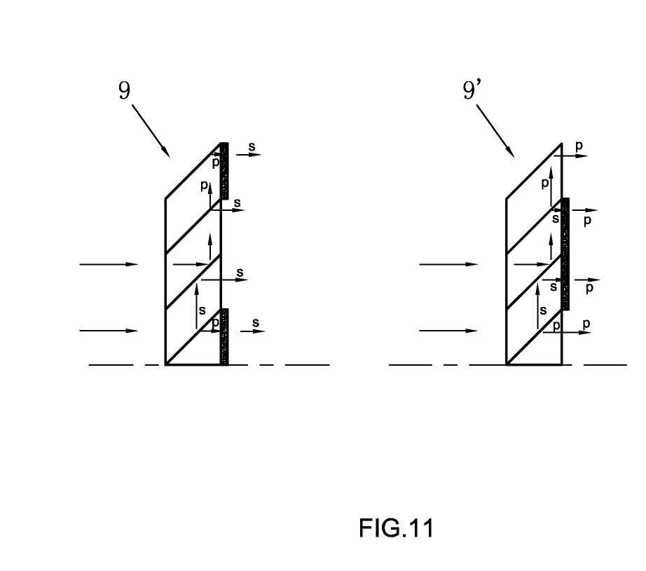

It also can be easily understood that no matter the polarization conversion apparatus 5 or the polarization conversion apparatus 5′, both have a symmetrical structure. That is, a half of the polarization conversion apparatuses 5 and 5′ having symmetrical structures can serve as a polarization converter 9 or 9′ (see FIG. 11), which is also capable of converting the natural light into light with s-polarization or light with p-polarization.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A polarization conversion apparatus capable of converting natural incident light into linear light with single polarization for emission, comprising:
(1) a first prism, a second prism, a third prism, a fourth prism, a fifth prism, a six prism and a seventh prism arrayed in that order as a whole component, wherein the fourth prism is a right-angled isosceles triangle prism or glued right-angled isosceles triangle prism composed of two right-angled triangle sub-prisms, and the first prism, the second prism, the third prism, the fifth prism, the sixth prism and the seventh prism are constant parallelogram prisms or glued parallelogram prisms composed of two right-angled triangle sub-prisms, and the first prism, the second prism, the third prism are arranged at one right-angled side of the fourth prism, and the fifth prism, the sixth prism and the seventh prism are arranged at the other right-angled side of the fourth prism and are symmetric relative to the first prism, the second prism, the third prism;
(2) a plurality of half-wave plates provided at all emission surfaces of the prisms from which light with p-polarization or s-polarization emit; and
(3) a first faying surface between the first prism and the second prism, a second faying surface between the second prism and the third prism, a third faying surface between the third prism and the fourth prism, a fourth faying surface between the fourth prism and the fifth prism, a fifth faying surface between the fifth prism and the sixth prism, a sixth faying surface between the sixth prism and the seventh prism, a first outer side surface of the first prism, and a second outer side surface of the seventh prism, wherein the first faying surface, the third faying surface, the fourth faying surface and the sixth faying surface comprise polarization beam splitting films formed thereon to form polarization beam splitting surfaces, and the first outer side surface, the second faying surface, the fifth faying surface and the second outer side surface comprise total reflection films formed thereon to form total reflection surfaces.

2. The polarization conversion apparatus of claim 1, wherein the polarization conversion apparatus is capable of converting natural incident light into light with s-polarization for emission, and the half-wave plates are arranged at the emission surfaces of the first prism, the fourth prism, and the seventh prism.

3. The polarization conversion apparatus of claim 1, wherein the polarization conversion apparatus is capable of converting natural incident light into light with p-polarization for emission, and the half-wave plates are arranged at the emission surfaces of the second prism, the third prism, the fifth prism, and the sixth prism.

4. The polarization conversion apparatus of claim 1, wherein the first prism, the second prism, the third prism, the fourth prism, the fifth prism, the sixth prism, and the seventh prism are glued together as a whole component, and the half-wave plates are glued to the respective prisms.

5. The polarization conversion apparatus of claim 1, wherein the incident surfaces of the second prism, the third prism, the fourth prism, the fifth prism, and the sixth prism cooperatively serve as effective light incident areas of the polarization conversion apparatus.

6. The polarization conversion apparatus of claim 5, further comprising light shielding layers arranged at the incident surfaces of the first prism and the seventh prism.

7. The polarization conversion apparatus of claim 1, wherein the total reflection layers are metal reflection films.

8. A projection system comprising: at least one light source, a polarization beam splitter, a display chip, and a projection lens, wherein the projection system further comprises the polarization conversion apparatus of claim 1, and the polarization conversion apparatus is located between the light source and polarization beam splitter and converts natural light from the light source into linear light with single polarization for the polarization beam splitter.

9. The projection system of claim 8, wherein light from the light source illuminates the incident surfaces of the second prism, the third prism, the fourth prism, the fifth prism, and the sixth prism of the polarization conversion apparatus.

10. The projection system of claim 9, further comprising light shielding layers provided at the incident surfaces of the first prism and the seventh prism.

11. The projection system of claim 8, wherein the polarization conversion apparatus and the polarization beam splitter are glued together as a whole component.

12. The projection system of claim 8, wherein natural light from the light source is converted into light with s-polarization by the polarization conversion apparatus and is further provided to the polarization beam splitter, and the half-wave plates are provided at the emission surfaces of the first prism, the fourth prism, and the seventh prism.

13. The projection system of claim 8, wherein natural light from the light source is converted into light with p-polarization and is further provided to polarization beam splitter, the light with p-polarization emitting from the polarization beam splitter illuminating the display chip and being further modulated into light with s-polarization by the display chip, and being then reflected to the projection lens by the polarization beam splitter, the half-wave plates being provided at the emission surfaces of the second prism, the third prism, the fifth prism, and the sixth prism.

14. The projection system of claim 8, further comprising a polarizer provided between the polarization beam splitter and the projection lens.

15. The projection system of claim 8, wherein the light source is selected from the group consisting of light emitting diodes, laser, and arrayed planar light sources, and the display chip is a single liquid crystal on silicon (LCOS) panel.

16. A projection system, comprising: a red light source, a green light source, a blue light source, a beam combining cubic prism, a polarization beam splitter, a liquid crystal on silicon (LCOS) panel, and a projection lens, wherein the red light source, the green light source, and the blue light source are provided corresponding to three side surfaces of the beam combining cubic prism, light from the light sources being combined into the polarization beam splitter, and being further split into linear light with polarization and provided to the LCOS panel, then the linear light with polarization being modulated by the LCOS panel, and being projected out the projection lens, wherein there is one polarization conversion apparatus between every light source and the beam combining cubic prism.

17. The projection system of claim 16, wherein the polarization conversion apparatus and the beam combining cubic prism are glued together as a whole component.

18. A polarization converter, wherein the polarization converter is symmetric half of the polarization conversion apparatus of claim 1.
